(19) United States
(12) Patent Application Publication
(10) Pub. No.: US 2002/0073023 A1
(43) Pub. Date: Jun. 13, 2002

(54) Method and system for interactively delivering business chamber resources via a remote computer network

(76) Inventors: Garry Castro, Denton, TX (US); Ed Franco, Dallas, TX (US); Arcilia Acosta, Grand Prairie, TX (US); James W. Feild, Dallas, TX (US); Andres Ruzo, Garland, TX (US)

Correspondence Address: Daniel F. Perez, Bickel & Brewer, 4800 Bank One Center, 1717 Main Street, Dallas, TX, 75201, US

(21) Appl. No.: 10/016,521

(22) Filed: Dec. 7, 2001

Related U.S. Application Data
(60) Provisional application No. 60/254,376, filed on Dec. 8, 2000.

(51) Int. Cl. G06F 17/60

(52) U.S. Cl. 705/38

(57) ABSTRACT

A method and system in a remote computer network for interactively delivering business chamber resources to business chamber customers via a web-based portal, wherein the remote computer network has at least one client connectable to one or more servers. A list of particularized supplier data is generated, in response to a particular user input, wherein the particularized supplier data is accessible via the web-based portal. In addition, interactive training data is displayed within the web-based portal, in response to a particular user input. Additionally banking and lending data is compiled that is tailored to a particular user, in response to a particular user input, wherein the compiled banking and lending data is accessible via the web-based portal. Finally, online business chamber management tools are displayed within the web-based portal dedicated to enhance business chamber management, communication and productivity. Four modules are provided to implement the method and system of the present invention, including a procurement module, an access-to-capital module, a training module, and a chamber management modules.

### CROSS REFERENCE TO RELATED PATENT APPLICATION

This patent application is related to provisional patent application, “Method And System For Interactively Delivering Business Chamber Resources Via A Remote Computer Network,” Serial No. 60/254,376, Attorney Docket No. B&B 1888-03, filed on Dec. 8, 2000. This patent application claims the Dec. 8, 2000 filing date of the above referenced patent application.

### FIELD OF THE INVENTION

The present invention is generally related to remote computer networks. In particular, the present invention is generally related to methods and systems that utilize remote computer networks to interact with and assist users and customers. More particularly, the present invention relates to web-based portals for delivering business chamber financial, management, and education resources and information to business chamber customers.

### BACKGROUND

The development of computerized information resources, such as the “Internet,” and the proliferation of “Web” browsers, permit users of data-processing systems to link to other servers and networks, and thus retrieve vast amounts of electronic information heretofore unavailable in an electronic medium. Such electronic information is increasingly displacing more conventional means of information transmission, such as newspapers, magazines, and even television. As a result of this displacement, commercial enterprises and endeavors previously practiced only by conventional means of information transmission, are now being implemented and practiced via the “Internet” and “Web” browsers.

The term “Internet” is an abbreviation of “Internetwork,” and refers to the collection of networks and gateways that utilize the TCP/IP suite of protocols, which are well known in the art of computer networking. TCP/IP is an acronym for “Transport Control Protocol/Interface Program,” a software protocol originally developed by the Department of Defense for communication between computers, but now primarily utilized as one of a number of standardized Internet communications protocols.

In the last decade of the 20^{th} century, explosive growth occurred in the use of the globally-linked network of computers now known as the “Internet.” In particular, the World Wide Web, or simply the “Web,” which facilitates the use of the Internet, has resulted in a revolution of electronic commerce and information transmission. The World Wide Web, well known in the Internet and computer networking arts, is composed of many pages or files of information distributed across a variety of computer servers and systems.

In order to utilize the World Wide Web, a client computer system runs a portion of software known as a graphical “Web” browser, such as Netscape Navigator or Internet Explorer. “Netscape” and “Navigator” are trademarks of the Netscape Communications Corporation, while “Internet Explorer” is a trademark of Microsoft. The client computer system interacts with the browser to select a particular Universal Resource Locator (URL), by which each page is identified. The URL denotes both the server machine, and the particular file or page on that machine. Many pages or URLs may reside on a single server. The selection of the URL in turn causes the browser to send a request for that URL or page to the server identified in the URL. Typically the server responds to the request by retrieving the requested page, and transmits the data for that page back to the requesting computer system. This page is then displayed to the user on the client screen. The client may also cause the server to launch an application, for example, to search World Wide Web “pages” relating to particular topics.

Most World Wide Web pages are formatted in accordance with a computer program written in a language known as HTML (hypertext mark-up language). This program contains the data to be displayed via the client's graphical browser as well as formatting commands which “tell” the browser how to display the data. Thus, a typical “Web” page includes text together with embedded formatting commands, referred to as “tags,” which can be utilized to control the font size, the font style (e.g., italic or bold), textual layout, and so forth. A Web browser “parses” the HTML script in order to display the text in accordance with the specified format. HTML tags are also utilized to indicate how graphics, audio, and video are manifested to the user via the client's browser.

The majority of Web pages also contain one or more references to other Web pages, which need not be on the same server as the original page. Such references may generally be activated by the user selecting particular locations on the screen, typically by clicking a mouse control button. These references or locations are known as hyperlinks, and are typically flagged by the browser in a particular manner (e.g., any text associated with a hyperlink may appear graphically in a different color). If a user selects the hyperlink, then the referenced page is retrieved and replaces the currently displayed page.

Commercial enterprises, organizations, and companies are actively utilizing the World Wide Web to initiate commerce. Several phases of electronic commerce via the World Wide Web have taken place. The first phase, namely publicity for companies and organizations, has already occurred. Homepages are commonplace, an essential ingredient for any company which wishes to maintain itself in line with current business practices. The publicity material posted electronically on company homepages contain marketing information, product brands, and in some cases, product catalogues.

The second phase, namely to conduct commerce, is emerging. Enterprises are poised to conduct business via the World Wide Web. They are seeking to make sales of their products and services, utilizing the World Wide Web. Software infrastructure is coming into existence to enable the progress of this trend. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and server machines owned and operated by companies and commercial enterprises.

Thus, many suppliers have begun to sell their goods and services over the World Wide Web by placing their catalogues on their Web pages. Such online catalogues list content-related information (e.g., product description, price, availability, and so forth) describing various goods and services offered for sale. They also list their business policies concerning, for example, cancellation policies.

The third phase of commercial World Wide Web development, namely, the business-to-business arena, is only now being seriously implemented. Web business-to-business solutions require two components. First, a customer must be willing to engage in commercial transactions via the World Wide Web. Second, the company or enterprise expecting customer participation must offer and implement a secure and efficient electronic information delivery system.

To date, such web-based business-to-business solutions have been mediocre at best, simply because the number of customers willing to participate in such solutions have been limited. While large corporations and commercial enterprises are increasingly willing to engage in web-based business-to-business solutions, many businesses have been reluctant to follow the lead of the larger companies. A need thus exists for a web-based business-to-business solution aimed at attracting businesses to the new electronic commerce environment.

A lack of financial, marketing and business development information for businesses has prevented enterprises from effectively engaging in electronic commerce. Most Web-based portals in existence today directed at entrepreneurs and businesses business typically are implemented in the form of a series of online brochures or catalogues. While adequate at providing basic business and financial information, such portals fail to satisfy customer preferences for marketing, supply information, procurement, management and access to financial capital offered by lending institutions.

Such web-based portals also fail to address the needs of local business promotion organizations, such as a Chamber of Commerce (i.e., business chamber). Many business chambers focus on promoting economic development in low-income and depressed areas of large metropolitan cities. Other business chambers target business growth in rural areas. Regardless of the geographical location serviced by particular business chambers, most business chambers face similar problems and needs. Many business chamber customers have expressed frustration with the lack of business knowledge provided by local business chambers, along with the increasing reluctance of lending institutions to make loans in association with restrictive lending practices. Although generally valuable at providing business development resources, many business chambers face the daunting task of communicating such resources to potential customers, investors, and lending institutions.

Business chambers typically provide four core functions. First, they provide a procurement role, served historically by face-to-face corporate visits. Second, business chambers deliver access-to-capital services, typically funded by local city governments or other organizations to provide training and education to under-served entrepreneurs, thereby acting as a loan facilitator. Third, business chambers provide a training and education function to teach access-to-capital and other management practices, such as credit repair. Finally, and fourth, business chambers must be involved in chamber management by facilitating processes that enable the chamber to maintain membership data, member billing, calendars, newsletters, member directories, awards, histories, and events.

To date, such core functions have been provided through face-to-face contact and traditional communication devices, such as phone, fax machine, and so forth. Such core business chamber functions to date have not been implemented automatically and interactively via remote computer networks, such as the World Wide Web. A need thus exists to implement such core business chamber functions to increase business chamber efficiency and provide increasing numbers of loans to those entrepreneurs who would otherwise not have access to a local business chamber due to geographical location or simply, a lack of awareness of services offered by local business chambers. It is believed that a web-based portal that implements these core functions would result not only in more efficiently run business chambers, but would also serve to promote cost-savings by providing such services to greater numbers of business chamber customers, investors, and lending institutions than are currently served today. In addition, it is anticipated that such a web-based portal would assist in increasing chamber membership.

### SUMMARY

It is one aspect of the present invention to provide an interactive web-based portal for a remote computer network.

It is another aspect of the present invention to provide a method and system in which user-tailored information is interactively rendered for a user based on user-provided information.

It is still another aspect of the present invention to provide a method and system in which user-tailored information is interactively rendered for a user based on user-provided information compiled via an electronic template.

It is yet another aspect of the present invention to provide a web-based portal for interactively delivering financial and business information to business chamber customers.

The above and other aspects of the present invention are achieved as is now described. A method and system in a remote computer network for interactively delivering business chamber resources to business chamber customers via a web-based portal, wherein the remote computer network has at least one client connectable to one or more servers. A list of particularized supplier data is generated, in response to a particular user input, wherein the particularized supplier data is accessible via the web-based portal. In addition, interactive training data is displayed within the web-based portal, in response to a particular user input. Additionally banking and lending data is compiled that is tailored to a particular user, in response to a particular user input, wherein the compiled banking and lending data is accessible via the web-based portal. Finally, online business chamber management tools are displayed within the web-based portal dedicated to enhance business chamber management, communication and productivity. Four modules are provided to implement the method and system of the present invention, including a procurement module, an access-to-capital module, a training module, and a chamber management modules.

### BRIEF DESCRIPTION OF DRAWINGS

FIG. 1 illustrates a pictorial representation of a computer system, which may be utilized to implement a preferred embodiment of the present invention;

FIG. 2 depicts a representative hardware environment of a computer system in which a preferred embodiment of the present invention can be implemented;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention;

FIG. 5 illustrates a block diagram of a computer network in which a preferred embodiment of the present invention can be implemented; and

FIG. 6 depicts a block diagram illustrating business chamber and web-based portal interactions, in accordance with a preferred embodiment of the present invention.

### DESCRIPTION OF PREFERRED EMBODIMENTS

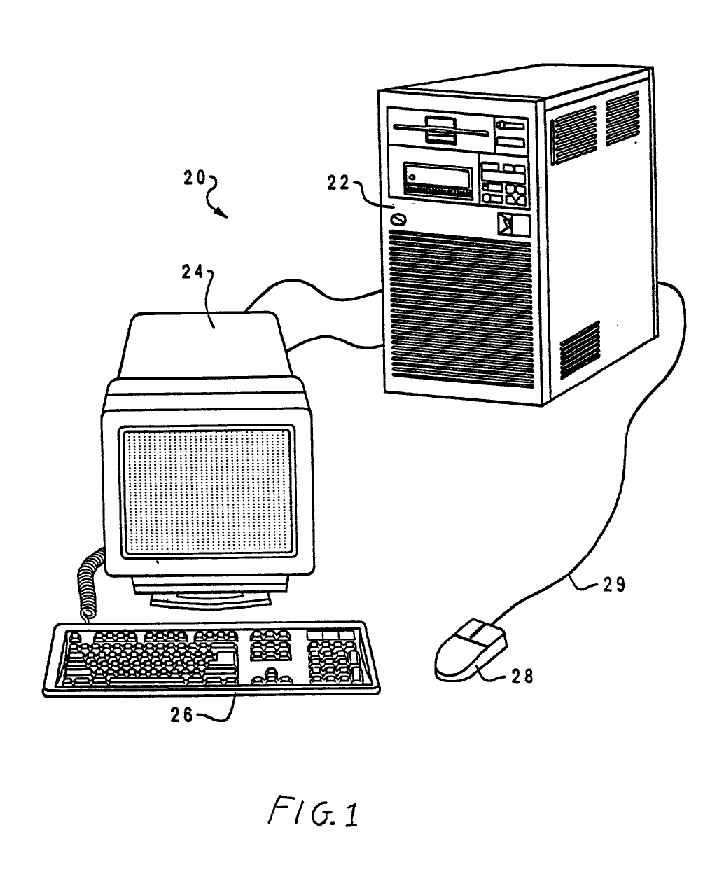

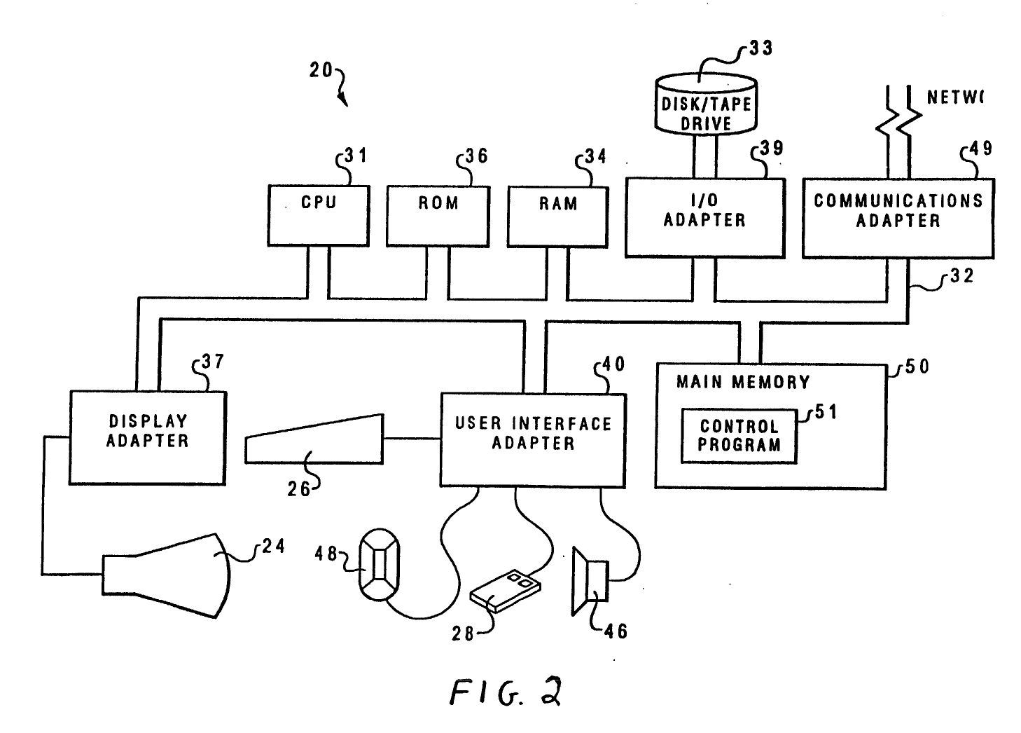

FIG. 1 illustrates a pictorial representation of a computer system 20, which may be utilized to implement a preferred embodiment of the present invention. Computer system 20 includes a system unit 22, a video display terminal 24, a keyboard 26, and a mouse 28. Those skilled in the art can appreciate that the method and system of the present invention apply equally to any computer system, regardless of whether the computer system is a complicated multi-user computing apparatus or a single-user workstation. In FIG. 1 and FIG. 2, like parts are identified by like numbers.

FIG. 2 depicts a representative hardware environment of a computer system in which a preferred embodiment of the present invention can be implemented. Computer system 20 includes a Central Processing Unit (“CPU”) 31, such as a conventional microprocessor, and a number of other units interconnected via system bus 32. Components and units of computer system 20 can be implemented in a system unit, such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 is the visual output of computer system 20. Video display terminal 24 can be a CRT-based video display well known in the art of computer hardware. In a portable or notebook-based computer, however, video display terminal 24 can be replaced with a gas plasma-based or LCD-based flat-panel display. Computer system 20 further includes user interface adapter 40 for connecting keyboard 26, mouse 28, speaker 46, microphone 48, and/or other user interface devices, such as a touch-screen device (not shown), to system bus 32. Communications adapter 49 connects computer system 20 to a computer network. Although computer system 20 is shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art can appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 is connected to system bus 32, and includes a control program 51. Control program 51 resides within main memory 50, and contains instructions that, when executed on CPU 31, carries out the operations depicted in the logic flow diagrams described herein. Control program 51, a computer program product, can also be referred too simply as a program product.

It is important to note that, while the present invention has been (and will continue to be) described in the context of a fully functional computer system, those skilled in the art can appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module is typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation is private in that it is only accessible by the module. The implementation also contains source code that actually implements the routines in the module. Thus, a program product can be formed from a series of interconnected modules or instruction modules dedicated to working together to accomplish a particular task.

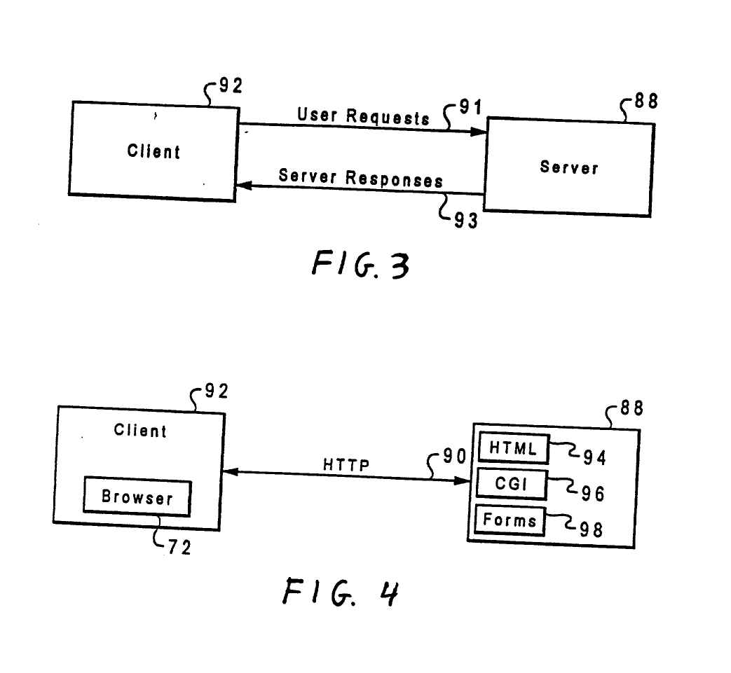

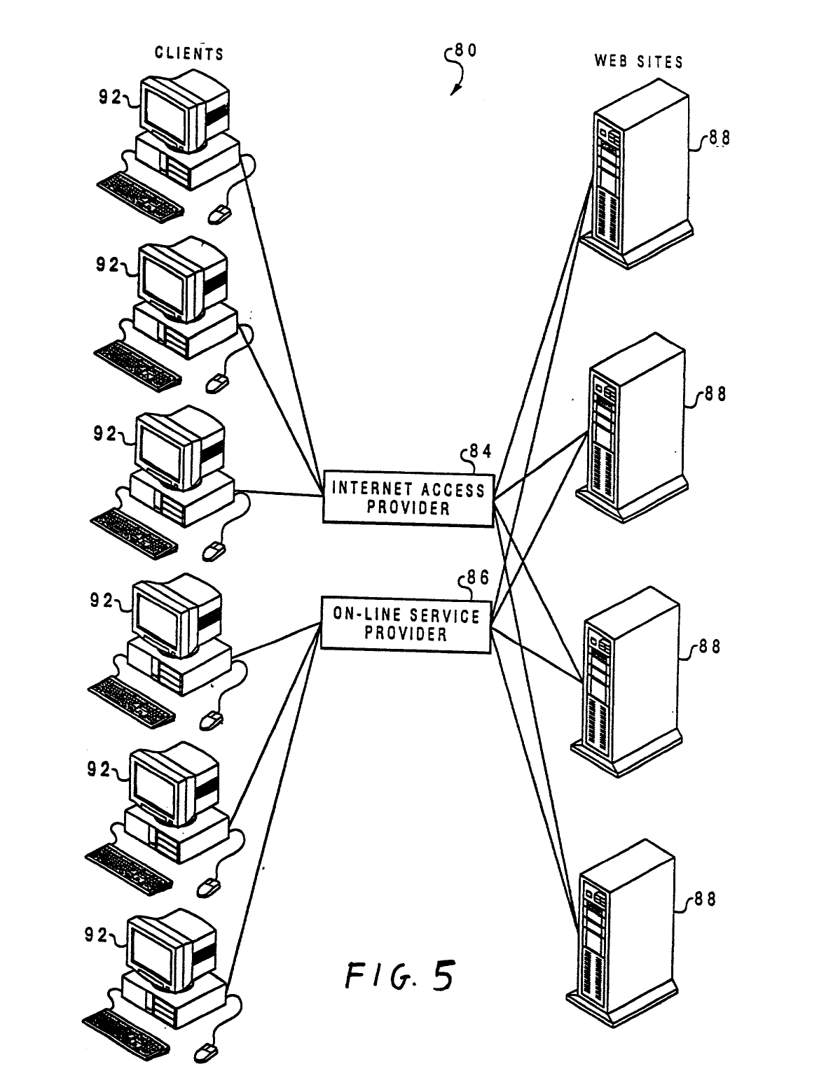

In FIG. 3, FIG. 4, and FIG. 5, like parts are indicated by like numbers. FIG. 3 illustrates a block diagram illustrative of a client/server architecture in accordance with a preferred embodiment of the present invention. In FIG. 3, user requests 91 for news are sent by a client application program 92 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 performs scanning and searching of raw (e.g., unprocessed) information sources (e.g., newswire feeds or newsgroups) and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the informationgathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which is interpreted and executed in a computer system at runtime (e.g., a workstation), it can be appreciated by one skilled in the art that they may be implemented in a variety of hardware devices, either programmed or dedicated.

Client 92 and server 88 communicate utilizing the functionality provided by HTTP. Active within client 92 is a first process, browser 72, which establishes connections with server 88, and presents information to the user. Any number of commercially or publicly available browsers can be utilized in various implementations in accordance with the preferred embodiment of the present invention. For example, the Mosaic-brand browser available from the National Center for Supercomputing Applications (NCSA) in Urbana-Champaign, Ill., can be utilized in accordance with a preferred embodiment of the present invention. Other browsers, such as Netscape™, also provide the functionality specified under HTTP. “Netscape” is a trademark of Netscape, Inc.

Server 88 executes the corresponding server software, which presents information to the client in the form of HTTP responses 90. The HTTP responses 90 correspond with the Web pages represented using HTML, or other data generated by server 88. Server 88 provides HTML 94. With certain browsers, a Common Gateway Interface (CGI) 96 is also provided, which allows the client program to direct server 88 to commence execution of a specified program contained within server 88. This may include a search engine that scans received information in the server for presentation to the user controlling the client.

By utilizing this interface, and HTTP responses 90, server 88 may notify the client of the results of that execution upon completion. Common Gateway Interface (CGI) 96 is one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This is provided by the “fill-in-forms” functionality (i.e., forms 98), that is provided by some browsers, such as the Netscape-brand browser described herein. This functionality allows the user via a client application program to specify terms in which the server causes an application program to function (e.g., terms or keywords contained in the types of stories/articles, which are of interest to the user). This functionality is an integral part of the search engine.

FIG. 5 is a diagram illustrative of a computer network 80, which can be implemented in accordance with a preferred embodiment of the present invention. Computer network 80 is representative of the Internet, which can be described as a known computer network based on the client-server model discussed herein. Conceptually, the Internet includes a large network of servers 88 that are accessible by clients 92, typically users of personal computers, through some private Internet access provider 84 (e.g., such as Internet America) or an on-line service provider 86 (e.g., such as America On-Line, Prodigy, Juno, and the like). Each of the clients 92 may run a browser to access servers 88 via the access providers. Each server 88 operates a so-called “Web site” that supports files in the form of documents and web pages. A network path to servers 88 is identified by a Universal Resource Locator (URL) having a known syntax for defining a network collection. Computer network 80 can thus be considered a web-based computer network.

In accordance with a preferred embodiment of the present invention, a web-based tool is described wherein standardized process controls are enabled for delivering specialized services to business chamber investor and customers. The Web-based tool described herein also automates the dissemination of information and documents user interest and responses thereof. Further, the Web-based tool described herein enables archiving, extensive reporting, and search capabilities, while creating educational libraries and explanatory documents. In addition, the Web-based tool described herein enables so-called data mining efforts and the ability to provide customized web-based portals dedicated to particular local markets, thereby permitting local markets to maintain a distinct local identity. The web-based portal can be configured to provide authoring tools that permit users to configure portions of the web-based portal as web-pages having local authored content, including streaming video, audio and other associated online media content.

module for permitting a user to access an online curriculum session;

module for recording a position of said user in said online curriculum session, if said user terminates said online curriculum session accessed by said user; and

module for resuming said online curriculum session at said position, in response to an immediately succeeding access of said online curriculum session by said user, thereby enabling said user to return to said online curriculum session at said user's personal convenience.

I. The system of claim 21 further comprising:

module for recording a particular amount of time associated with said online curriculum session.

II. The system of claim 22 further comprising:

module for permitting said user to author particular web-based content utilizing predefined web-based authoring tools accessible through said web-based portal. Such predefined web-based authoring tools thus permits users to configure particular web-based content to match the needs or focus on a given local market. The Web-based tool described herein thus promotes a sustainable income stream by providing value-added services for business chamber customers and investors.

The Web-based tool is composed of four modules: an access-to-capital module, a procurement module, a training and education module, and a chamber management module. The access-to-capital module is a multi-layered set of tools and electronic reports providing a set of dedicated financial and investment tools, including a tool that permits participating banks and lending sources to describe their business and consumer lending products, particularly products targeted to under-served demographic segments. A Web-page associated with the access-to-capital module refers a user to a Community Development Corporation (CDC) storefront, or directly to a lender. Lenders are provided with the ability, via the access-to-capital module, to monitor the associated Web pages, and request updates, changes and introduce new products. User or lender usage can be tracked and reported periodically to interested users and lenders via e-mail.

Potential borrowers can apply online via the access-to-capital module utilizing a secure socket layer assuring applicant privacy, or, if potential borrowers visit a CDC storefront, application data is entered directly into a central applicant database via a secure intranet connection. The term “Intranet” refers to networks designed for information processing with a company, enterprise, or organization, and typically provides services, such as document distribution, software distribution, database access, software distribution, and training. An Intranet network typically utilizes applications associated with the Internet, such as Web pages, Web browsers, FTP sites, e-mail, newsgroups, and mailing lists, accessible only to those within the company, enterprise or organization. The term “Intranet” is well-known in the art. Thus, applicant data is maintained updated, and processed for referral and reporting via the access-to-capital module.

The access-to-capital module additionally incorporates a tracking and reporting feature, whereby all applications are tracked and reported. Reports are generated that indicate which stage of the referral process the application is pending. For example, a report can be generated indicating that the access-to-capital module is currently awaiting missing data, or that a loan has been made or referred to another agency. Thus, applicant, assigned staff, office location and other indexes generated during the application and referral process by the access-to-capital module and be tracked and reported.

The procurement services module is a Web-based tool for reaching, tracking and reporting potential suppliers. This module is suitable for use by both public and private organizations. It provides multi-layered information regarding procurement opportunities with full tracking and reporting capabilities. The procurement module enables an online self-administered posting and notification service, wherein purchasing personnel can post purchasing opportunities utilizing industry specific codes. Posting activates an automated notification system, wherein automated notifications are generated and sent via e-mail or fax to previously identified and registered potential suppliers. Supplier inquiries can be referred to particular telephone number, an individual's e-mail address, or an anonymous e-mail address having auto-responding capabilities. Upon expiration of the posting, the posted information is automatically archived in a company archive account or database. Reports are generated, via the procurement module, indicating customer or user interest, response tracking, as well as history of user responses and interest indications.

The training education module contains training and educational materials and programs accessible via the Web-based portal described herein. Training, via the Web-based portal, focuses on the education of businesses and customers. For example, training and education for start-up or expanded business programs is provided via the training and education module, as well as tips and assistance in applying for a business or personal loan. In addition, the training and education module provides ideas and templates for marketing and other business functions, as well as lessons on how to leverage technology in a business environment. Business certification programs can also be administered and run via the training and education modules for customers and users, along with specialized training programs (e.g., advertising, marketing, and so forth). Those skilled in the art can appreciate that a wide variety of educational and training programs can be implemented via the training and education module, including college level credit courses, and continuing education seminars and programs. Training and education courses can be implemented in the web-based portal as an online curriculum. A user thus logs onto the web-based portal and then accesses the online curriculum to initiate an online curriculum session. The amount of time that the user spends on a given online curriculum session can be recorded and tracked. Thus, the web-based portal includes a module for recording the position of the user in a given online curriculum session at the time that the user terminates said online curriculum session accessed. That position or location is then resumed during the next succeeding online curriculum session accessed by the user, thereby enabling the user to return to the online curriculum session at the user's personal convenience. The amount of time that the user spends on a given online curriculum session can be thus recorded and logged for time tracking purposes.

The chamber management module is composed of a suite of web-based tools that business chambers can utilize, regardless of their geographical location, to improve the communication, management, and productivity of their staff and membership. Such a module includes an online membership directory, static informational pages, an online chamber newsletter, an online chamber calendar, a knowledge library, a search engine, and employment opportunities.

The online membership directory utilizes standard industry codes (NAIC/SIC) to classify businesses according to particular categories within the online directory. The online membership directory is a self-administered directory that enables members to dynamically add, delete, or change products or services. The online membership directory permits publication of an array of online information for use by procurement personal in the context of Internet business-to-business services. The online membership directory can also be utilized to promote products and services directly to consumers, as well as provide feature text, graphic, and photo capabilities for chamber members.

The chamber management module also provides static informational pages that can be customized to provide information about a particular chamber's history, awards, services, and membership. The information is presented via static Web pages. The pages are “static” they are designed to convey standard information about the chamber. The information can be changed, but is not typically presented in an interactive format.

The chamber management module further includes an online chamber newsletter. Like its printed counterpart, the online chamber Newsletter features regular departments and sections. Online publishing tools enable the letter to be published and displayed online via the Web-based portal described herein, while enabling chamber staff to update key information quickly and easily.

The chamber management module further includes an online chamber calendar that enables members to view a graphically displayed calendar of upcoming events. Committees and boards can utilize the online chamber calender to keep members updated on meetings and progress. Additionally, the chamber management modules provides a knowledge library organized as a repository of information that particular chamber committees and chamber board of directors contribute. Portions of the knowledge library are password protected to insure appropriate confidentiality.

Additionally, the chamber management modules provides a search engine, whereby internal documents and resources are searchable by index, key word or key phrase. Because chamber membership and leadership churns, the ability to research subjects can save countless hours reimplementing tasks and processes. Employment opportunities are also provided via the chamber management modules. Chamber members can list job postings in a self-administering section that accommodates page links to employer websites and/or email links to interested parties. Reports can be compiled to document interest or hits.

Based on the foregoing, it can be appreciated by those skilled in the art that the present invention is composed of a suite of modules that can add value to business chambers throughout the nation. The modules, when implemented according to the method and system described herein, provide a Web-based portal that can be utilized by a variety of business chambers, regardless of location and primary purpose. Users need only have a computer equipped with a Web browser, such as those described herein, in order to access, by permission, to specific and/or chamber areas utilizing a series of passwords. Users are restricted to specific areas. User access to such areas can be controlled and monitored.

To the individual user, the graphically displayed Web-pages and content appear customized to a specific local market. Investors can thus “turn on” different markets for a fraction of the cost of the original build. It is anticipated that monthly maintenance fees can be charged per market. In addition, a one time market setup fee can be charged to cover the cost of rolling out a new market. Should a new market require or request special customizations, the cost of such customizations are charged according to the market making the request.

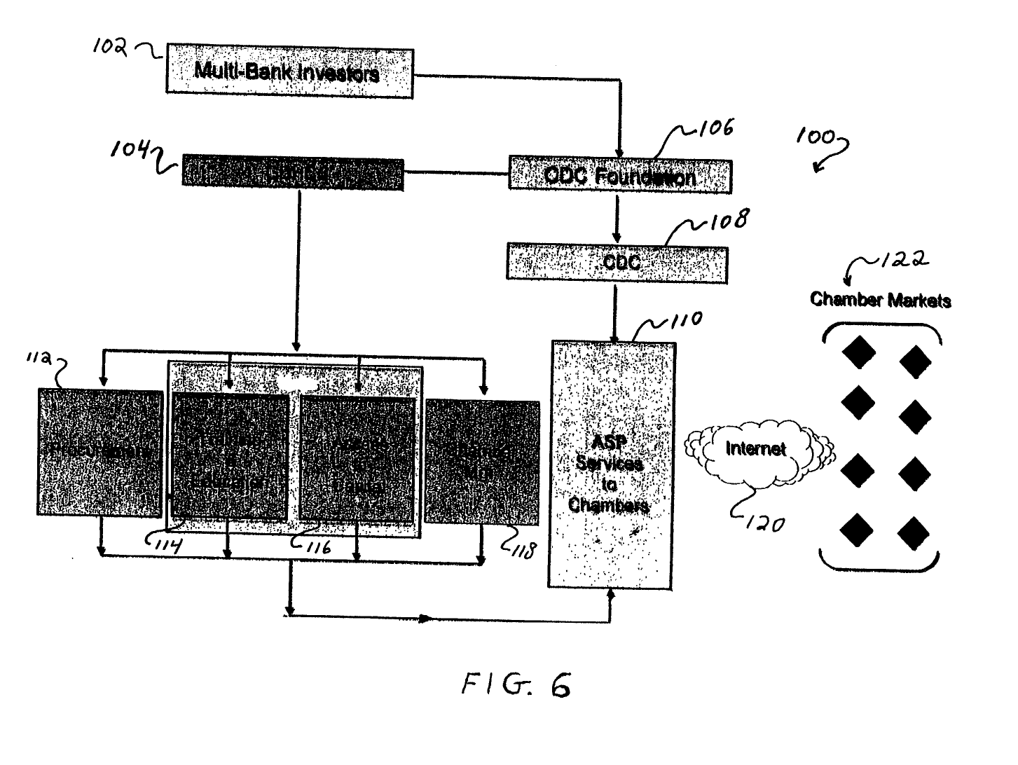

FIG. 6 depicts a block diagram 100 illustrating business chamber and web-based portal interactions, in accordance with a preferred embodiment of the present invention. As indicated at block 108, a Community Development Corporation (CDC) interacts with both a CDC Foundation, as illustrated at block 106 and an Application Service Provider dedicated to providing chamber services, as depicted at block 110. A CDC is a vehicle through which banks can support lending activities in markets that they cannot reach efficiently and effectively themselves. Of the multi-bank CDC's involved in business lending, only a few can be termed “successful” in terms of either significant loan volume or the CDC's own financial condition. CDC's must have a comprehensive plan and structure through which they can address their market needs, have a significant impact, and become financially stable and, ideally, self-sufficient.

Many of the issues and challenges faced by multi-bank CDC's and their successful practices are the same as those faced by other financial intermediaries active in community development. The CDC's staff and leadership must be lean, dedicated, experienced, and effective, which is true of any organization. The CDC must have a defined mission that serves a clear market, which receives the support of its board, loan committee and bank members. As described at block 102, multi-bank investors provide investment support and loans to a CDC via a CDC foundation, as depicted at block 106.

Although customers of a typical CDC, or any community development financial institution for that matter, are typically “high-touch,” the CDC must quickly and steadily build a portfolio that generates the interest and fee revenues necessary to support the CDC's costs. This can be accomplished be developing new products as necessary and utilizing disciplined, but not rigid underwriting standards.

Most CDC's struggle to become self-sustainable, requiring considerable subsidies and in-kind support. While a low cost of funds is ideal to the CDC, it is not the ideal return to prospective banks considering membership. Nonprofit CDC's have the advantage of being eligible for stand and local grants to support administrative costs, but an on-going need to satisfy such compensation issues questions the ability of the CDC model to become self-sufficient.

Some CDC's have been able to break free from the mold, achieving both profitability and loan volume. Generally, it is evident that larger loan amounts enable a CDC to achieve profitability. To provide small loans, a CDC's best method may be to maintain a portfolio of larger loans, as well as the smaller loans. CDC's which are capitalized with equity or low to zero interest loans are able to passively earn income from idle funds, which is often a vital source of revenue in the early stages of a CDC's operation.

Thus, based on the foregoing, it can be appreciated that a strong basis for a CDC to specialize in pre-loan services exists. Utilizing the multi-bank approach, as illustrated at block 102, banks can invest in a community-based effort to more efficiently and effectively reach under-served markets. Thus, according to the configuration depicted in block diagram 100, the CDC focuses on marketing and pre-loan services for a few, thereby requiring the CDC to carefully track and report both business and consumer applicants via an Application Service Provider (ASP), as illustrated at block 110.

Essentially, such tracking and report tasks are provided via a Web-based portal over a computer network, such as the Internet, as represented by block 120. In turn, customer markets, as illustrated at block 122, are served. Four core functions are provided via the Web-based portal, namely, procurement, as illustrated at block 112, training and education, as indicated at block 114, access-to-capital, as described at block 116, and chamber management, as indicated at block 118. These core functions are processed and provided for chamber markets through a module implemented configuration, thereby providing a Web-based application. In the example of FIG. 6, a business chamber represented by the acronym GDHCC (Greater Dallas Hispanic Chamber of Commerce), as illustrated at block 104, provides the aforementioned core functions by implementing appropriate modules through a Web-based portal.

Those skilled in the art can appreciate that block diagram 100 thus depicts a refer-and-track strategy serving participating lending organizations, such as banks and other alternate lenders or asset-based lenders, which minimizes the risk associated with administering loans, thereby enabling a pre-loan service focus. Pre-loan services are delivered to target neighborhoods. Such services offered include community outreach, business plans, training and education, credit scoring, loan packaging, credit repair, referral to appropriate lenders, and post referral tracking and reporting. Market and referral services include consumer loan services, such as home loans, auto loans, and home improvement loans. The aforementioned services can thus be implemented via the Web-based interactive e-commerce solution described herein, thereby supporting a financial resource center, procurement, training and education, and chamber management capable of offering full or partial functionality in markets throughout the United States.

The embodiments and examples set forth herein are presented in order to best explain the present invention and its practical applications and to thereby enable those skilled in the art to make and utilize the invention. Those skilled in the art can recognize that the foregoing description and examples have been presented for the purposes of illustration and example only. The description as set forth herein is not intended to be exhaustive or to limit the invention to the precise form disclosed. For example, those skilled in the art can appreciate that the present invention can be utilize not only in the financial industries and arts, but a wide variety of other industries. Many modifications and variations are possible in light of the above teaching without departing from the spirit and scope of the following claims.

1. A method in a remote computer network for interactively delivering business chamber resources to business chamber customers via a web-based portal, wherein said remote computer network has at least one client connectable to one or more servers, said method comprising the steps of:
generating a list of particularized supplier data, in response to a particular user input, wherein said particularized supplier data is accessible via said web-based portal;
displaying interactive training data, in response to a particular user input, wherein said interactive training data is displayed within said web-based portal;
compiling banking and lending data tailored to a particular user, in response to a particular user input, wherein said compiled banking and lending data is accessible via said web-based portal; and
displaying online business chamber management tools within said web-based portal dedicated to enhancing business chamber management, communication and productivity.

2. The method of claim 1 wherein the step of generating a list of particularized supplier data, in response to a particular user input, wherein said particularized supplier data is accessible via said web-based portal, further comprises the steps of:
compiling a supplier database having supply data therein;
analyzing said supply database in response to a user request to view particular supply data;
automatically notifying a particular supplier associated with said particular supply data;
permitting said supplier to contact said user, in response to automatically notifying said particular supplier associated with said particular supply data, thereby enabling a procurement opportunity for said user; and
automatically tracking entries of said user to compile a history of said user's purchasing opportunities and supply data questions.

3. The method of claim 2 wherein the step of displaying interactive training data, in response to a particular user input, wherein said interactive training data is displayed within said web-based portal, further comprises the steps of:
prompting a user to select particular training data;
displaying training data via an online curriculum within said web-based portal, in response to a user selection of particular training data;
accessing said online curriculum;
interactively permitting user to provide user feedback, in response to accessing said online curriculum; and
evaluating said user feedback to provide educational and training responses thereof.

4. The method of claim 3 wherein the step of compiling banking and lending data tailored to a particular user, in response to a particular user input, wherein said compiled banking and lending data is accessible via said web-based portal, further comprises the step of:
permitting lending institutions to post banking and lending data within said web-based portal;
prompting a user to select particular banking and lending data from said web-based portal;
tracking said user's selections and responses thereof.

5. The method of claim 4 wherein the step of compiling banking and lending data tailored to a particular user, in response to a particular user input, wherein said compiled banking and lending data is accessible via said web-based portal, further comprises the step of:
analyzing user-provided financial data from a user;
referring said user to a particular lending institution; and
generating an online application template by which a user may enter data to request a loan from said particular lending institution, if said user indicates a desire to apply for a loan from said particular lending institution.

6. The method of claim 5 wherein the step of displaying online business chamber management tools within said web-based portal dedicated to enhancing business chamber management, communication and productivity, further comprises the steps of:
compiling an online chamber membership directory according to industry codes;
organizing said online chamber membership directory according categories based on said industry codes;
permitting a user to update said online chamber membership directory via said web-based portal.

7. The method of claim 6 wherein the step of displaying online business chamber management tools within said web-based portal dedicated to enhancing business chamber management, communication and productivity, further comprises the steps of:
compiling an online library of business chamber member-contributed data; and
permitting a user to access said online library via said web-based portal.

8. The method of claim 7 further comprising the step of:
permitting selected users to remotely customize said web-based portal to display information tailored to a particular local market.

9. The method of claim 8 wherein the step of accessing said online curriculum, further comprises the steps of:
permitting a user to access an online curriculum session;
recording a position of said user in said online curriculum session, if said user terminates said online curriculum session accessed by said user; and
resuming said online curriculum session at said position, in response to an immediately succeeding access of said online curriculum session by said user, thereby enabling said user to return to said online curriculum session at said user's personal convenience.

10. The method of claim 9 further comprising the step of:
recording a particular amount of time associated with said online curriculum session.

11. The method of claim 10 further comprising the step of:
permitting said user to author particular web-based content utilizing predefined web-based authoring tools accessible through said web-based portal.

12. The method of claim 11 further comprising the step of:
configuring said particular web-based content to a particular local market utilizing said predefined web-based authoring tools.

13. A system in a remote computer network for interactively delivering business chamber resources to business chamber customers via a web-based portal, wherein said remote computer network has at least one client connectable to one or more servers, said system comprising:
procurement module for generating a list of particularized supplier data, in response to a particular user input, wherein said particularized supplier data is accessible via said web-based portal;
training module for displaying interactive training data, in response to a particular user input, wherein said interactive training data is displayed within said web-based portal;
access-to-capital module for compiling banking and lending data tailored to a particular user, in response to a particular user input, wherein said compiled banking and lending data is accessible via said web-based portal; and
chamber management module for displaying online business chamber management tools within said web-based portal dedicated to enhancing business chamber management, communication and productivity.

14. The system of claim 13 wherein said procurement module further comprises:
module for compiling a supplier database having supply data therein;
module for analyzing said supply database in response to a user request to view particular supply data;
module automatically notifying a particular supplier associated with said particular supply data;
module for permitting said supplier to contact said user, in response to automatically notifying said particular supplier associated with said particular supply data, thereby enabling a procurement opportunity for said user; and
module for automatically tracking entries of said user to compile a history of said user's purchasing opportunities and supply data questions.

15. The system of claim 14 wherein said training module further comprises:
module for prompting a user to select particular training data;
module for displaying training data via an online curriculum within said web-based portal, in response to a user selection of particular training data;
module for accessing said online curriculum;
module for interactively permitting user to provide user feedback, in response to accessing said online curriculum; and
module for evaluating said user feedback to provide educational and training responses thereof.

16. The system of claim 15 wherein said access-to-capital module further comprises:
module for permitting lending institutions to post banking and lending data within said web-based portal;
module for prompting a user to select particular banking and lending data from said web-based portal; and
module for tracking said user's selections and responses thereof.

17. The system of claim 16 wherein said access-to-capital module further comprises:
module for analyzing user-provided financial data from a user;
module for referring said user to a particular lending institution; and
module for generating an online application template by which a user may enter data to request a loan from said particular lending institution, if said user indicates a desire to apply for a loan from said particular lending institution.

18. The system of claim 17 wherein said chamber management module further comprises:
module for compiling an online chamber membership directory according to industry codes;
module for organizing said online chamber membership directory according categories based on said industry codes; and
module for permitting a user to update said online chamber membership directory via said web-based portal.

19. The system of claim 18 wherein said chamber management module further comprises:
module for compiling an online library of business chamber member-contributed data; and
module for permitting a user to access said online library via said web-based portal.

20. The system of claim 19 further comprising:
module for permitting selected users to remotely customize said web-based portal to display information tailored to a particular local market.

21. The system of claim 20 wherein the step of accessing said online curriculum, further comprises:
module for permitting a user to access an online curriculum session;
module for recording a position of said user in said online curriculum session, if said user terminates said online curriculum session accessed by said user; and
module for resuming said online curriculum session at said position, in response to an immediately succeeding access of said online curriculum session by said user, thereby enabling said user to return to said online curriculum session at said user's personal convenience.

22. The system of claim 21 further comprising:
module for recording a particular amount of time associated with said online curriculum session.

23. The system of claim 22 further comprising:
module for permitting said user to author particular web-based content utilizing predefined web-based authoring tools accessible through said web-based portal.

24. The system of claim 23 further comprising
module for configuring said particular web-based content to a particular local market utilizing said predefined web-based authoring tools.

25. A program product residing in computer memory in a remote computer network for interactively delivering business chamber resources to business chamber customers via a web-based portal, wherein said remote computer network has at least one client connectable to one or more servers, said program product comprising:
procurement module residing in a computer for generating a list of particularized supplier data, in response to a particular user input, wherein said particularized supplier data is accessible via said web-based portal;
training module residing in a computer for displaying interactive training data, in response to a particular user input, wherein said interactive training data is displayed within said web-based portal;
access-to-capital module residing in a computer for compiling banking and lending data tailored to a particular user, in response to a particular user input, wherein said compiled banking and lending data is accessible via said web-based portal; and
chamber management module residing in a computer for displaying online business chamber management tools within said web-based portal dedicated to enhancing business chamber management, communication and productivity.

26. The program product of claim 25 wherein said procurement module further comprises:
module residing in a computer for compiling a supplier database having supply data therein;
module residing in a computer for analyzing said supply database in response to a user request to view particular supply data;
module residing in a computer for automatically notifying a particular supplier associated with said particular supply data;
module residing in a computer for permitting said supplier to contact said user, in response to automatically notifying said particular supplier associated with said particular supply data, thereby enabling a procurement opportunity for said user; and
module residing in a computer for automatically tracking entries of said user to compile a history of said user's purchasing opportunities and supply data questions.

27. The program product of claim 26 wherein said training module further comprises:
module residing in a computer for prompting a user to select particular training data;
module residing in a computer for displaying training data via an online curriculum within said web-based portal, in response to a user selection of particular training data;
module residing in a computer for accessing said online curriculum;
module residing in a computer for interactively permitting user to provide user feedback, in response to accessing said online curriculum; and
module residing in a computer for evaluating said user feedback to provide educational and training responses thereof.

28. The program product of claim 27 wherein said access-to-capital module further comprises:
module residing in a computer for permitting lending institutions to post banking and lending data within said web-based portal;
module residing in a computer for prompting a user to select particular banking and lending data from said web-based portal; and
module residing in a computer for tracking said user's selections and responses thereof.

29. The program product of claim 28 wherein said access-to-capital module further comprises:
module residing in a computer for analyzing user-provided financial data from a user;
module residing in a computer for referring said user to a particular lending institution; and
module residing in a computer for generating an online application template by which a user may enter data to request a loan from said particular lending institution, if said user indicates a desire to apply for a loan from said particular lending institution.

30. The program product of claim 29 wherein said chamber management module further comprises:
module residing in a computer for compiling an online chamber membership directory according to industry codes;
module residing in a computer for organizing said online chamber membership directory according categories based on said industry codes; and
module residing in a computer for permitting a user to update said online chamber membership directory via said web-based portal.

31. The program product of claim 30 wherein said chamber management module further comprises:
module residing in a computer for compiling an online library of business chamber member-contributed data; and
module residing in a computer for permitting a user to access said online library via said web-based portal.

32. The program product of claim 31 further comprising:
module residing in a computer for permitting selected users to remotely customize said web-based portal to display information tailored to a particular local market.

33. The program product of claim 32 wherein the step of accessing said online curriculum, further comprises:
instruction module residing in a computer for permitting a user to access an online curriculum session;
instruction module residing in a computer for recording a position of said user in said online curriculum session, if said user terminates said online curriculum session accessed by said user; and
instruction module residing in a computer for resuming said online curriculum session at said position, in response to an immediately succeeding access of said online curriculum session by said user, thereby enabling said user to return to said online curriculum session at said user's personal convenience.

34. The program product of claim 33 further comprising:
instruction module residing in a computer for recording a particular amount of time associated with said online curriculum session.

35. The program product of claim 34 further comprising:
instruction module residing in a computer for permitting said user to author particular web-based content utilizing predefined web-based authoring tools accessible through said web-based portal.

36. The program product of claim 35 further comprising
instruction module residing in a computer for configuring said particular web-based content to a particular local market utilizing said predefined web-based authoring tools.

37. The program product of claim 36 wherein each of said instruction modules further comprise signal-bearing media.

38. The program product of claim 37 wherein said signal-bearing media comprises transmission media.

39. The program product of claim 38 wherein said signal-bearing media comprises recordable media.
